(19) United States
(12) Patent Application Publication
(10) Pub. No.: US 2026/0266246 A1
(43) Pub. Date: Sep. 10, 2026

(54) METHOD FOR UTILIZING REFRIGERANT, AND ARRANGEMENT FOR IMPLEMENTING THE METHOD

(71) Applicant: Ford Global Technologies, LLC, Dearborn, MI (US)

(72) Inventors: Bart Wilhelmus Schmitz, Wassenberg (DE); Bernd Dienhart, Koeln (DE)

(73) Assignee: Ford Global Technologies, LLC, Dearborn, MI (US)

(21) Appl. No.: 19/559,575

(22) Filed: Mar. 6, 2026

(30) Foreign Application Priority Data
Mar. 6, 2025 (DE) 10 2025 108 460.2

(51) Int. Cl. F02M 25/00; B60H 1/32; F02M 35/10

(52) U.S. Cl. CPC F02M 25/00; B60H 1/3229; F02M 35/10209

(57) ABSTRACT

A method for utilizing a refrigerant, which has been discharged from a vehicle air-conditioning system, in a vehicle having an internal combustion engine is provided. The refrigerant is discharged via a pressure relief valve provided in the vehicle air-conditioning system. The refrigerant that has been discharged from the vehicle air-conditioning system via the pressure relief valve is fed to the internal combustion engine.

### CROSS-REFERENCE TO RELATED APPLICATION

This application claims priority to and the benefit of German Patent Application No. 102025108460.2, filed on Mar. 6, 2025. The disclosure of the above application is incorporated herein by reference.

### FIELD

The present disclosure relates to a method for utilizing refrigerant in a vehicle having an internal combustion engine.

### BACKGROUND

The statements in this section merely provide background information related to the present disclosure and may not constitute prior art.

Generally, vehicle air-conditioning systems are for controlling the temperature of the fresh air that is introduced into the interior compartment of the vehicle, and the vehicle air-conditioning systems may include at least one compressor, a condenser, an expansion valve and an evaporator, which are interconnected in the stated sequence to form a refrigerant circuit.

To protect the vehicle air-conditioning system against malfunctions or issues that could arise as a result of an overpressure, a pressure relief element in the form of a pressure relief valve may be arranged in the vehicle air-conditioning system. The pressure relief valve opens if the pressure in the refrigerant circuit overshoots a particular threshold. The pressure threshold may for example lie in a range between 20 bar and 40 bar. A reason for such a high pressure in the refrigerant circuit of the vehicle air-conditioning system may be a high outside temperature or an issue in the refrigerant circuit of the vehicle air-conditioning system.

By discharging the pressurized refrigerant, the pressure relief valve protects the vehicle air-conditioning system from issues caused by said overpressure, or by a resulting high temperature of the refrigerant. The service life of the vehicle air-conditioning system is thus lengthened.

If the refrigerant is a CFC-free refrigerant such as R290 (propane), a discharged refrigerant can contribute to effects in the atmosphere. The discharged refrigerant can occur in such an amount in the region of the vehicle that, if the refrigerant mixes with oxygen in the ambient air, an issue may occur.

The prior art has disclosed methods in which the refrigerant discharged from the vehicle air-conditioning system is captured.

For example, DE 195 29 885 C1 has disclosed a refrigeration system, in particular an air-conditioning system, for a motor vehicle. Refrigerant that is discharged in the event of a departure from specified operating conditions is captured in a pressure vessel and therefore does not enter the environment. The total refrigerant quantity captured in the pressure vessel can then be recycled again during maintenance service work, when the pressure vessel is emptied. An example is disclosed in which the refrigerant flowing out via the pressure relief valve is liquefied before being stored in the pressure vessel, for which purpose a condenser is connected upstream of the pressure vessel, and a compressor is connected upstream of the condenser. The condenser is assigned a blower for generating cooling air. The blower and compressor are activated when desired by means of a pressure switch that detects the pressure in the line downstream of the pressure relief valve.

Thus, additional assemblies such as a further compressor, a condenser and a blower are utilized. In an alternative example, although it is proposed to dispense with the additional assemblies discussed above, this results in a very small storage volume for the discharged refrigerant, or in a greatly increased space for the pressure vessel.

### SUMMARY

This section provides a general summary of the disclosure and is not a comprehensive disclosure of its full scope or all of its features.

The disclosure relates to a method and an arrangement for utilizing a refrigerant, which has been discharged from a vehicle air-conditioning system, in a vehicle having an internal combustion engine.

The present disclosure provides an arrangement for utilizing a refrigerant, which has been discharged from a vehicle air-conditioning system, in a vehicle, which method and arrangement enable meaningful utilization of the discharged refrigerant. It is also sought to permit such utilization of the discharged refrigerant without any further significant space footprint in the vehicle.

The present disclosure provides a method for utilizing a refrigerant, which has been discharged from a vehicle air-conditioning system, in a vehicle having an internal combustion engine.

Disclosed is a method for utilizing a refrigerant, which has been discharged from a vehicle air-conditioning system, in a vehicle having an internal combustion engine, in which method the refrigerant is discharged via a pressure relief valve provided in the vehicle air-conditioning system, wherein the refrigerant that has been discharged from the vehicle air-conditioning system via the pressure relief valve is fed to the internal combustion engine.

Note that the features and measures individually specified in the following description may be combined with one another in any technically meaningful way and reveal further refinements of the disclosure. The description additionally characterizes and specifies the disclosure, in particular in conjunction with the figures.

The disclosure provides a method and an arrangement for utilizing a refrigerant, which has been discharged from a vehicle air-conditioning system, for a motor vehicle. Here, the term “motor vehicle” refers in the narrower sense to a road vehicle, that is to say a vehicle that is suitable and approved for on-road use and has its own drive motor. The drive motor may be an internal combustion engine or a hybrid drive comprising an internal combustion engine. The motor vehicle may in particular be a passenger car, a heavy goods vehicle or a bus. In one example, the motor vehicle has at least two axles each having two wheels, though deviations from this are also conceivable. The motor vehicle may be controllable at least intermittently by a driver. It may however also be designed to at least intermittently drive autonomously, that is to say without being controlled by a driver. For the sake of conciseness, the motor vehicle will hereinafter also be referred to as “vehicle.”

In one example, the discharged refrigerant is fed to the inlet side of the internal combustion engine and, during the operation of the internal combustion engine, is burned in the chambers of the cylinder of the internal combustion engine together with a conventional fuel-air mixture. The energy contained in the discharged refrigerant is thus targetedly converted in the internal combustion engine into mechanical energy, as is known for example from the use of an fuel-air mixture in the internal combustion engine.

A refrigerant used in a vehicle air-conditioning system, which is for example a refrigerant with the designation R290, is a hydrocarbon having the chemical compound C3H8. The exemplary refrigerant R290 thus resembles a fuel having a general chemical compound conforming to CxHx. The refrigerant R290 can thus be fed to the internal combustion engine and burned in the chambers of the cylinders of the internal combustion engine. A refrigerant quantity of for example 100 g R290 corresponds to a volume of approximately 56.6 I at ambient pressure.

A specific gas constant for the refrigerant R290 (propane C3H8) is R=188.5 J/(kg K). In general, the specific gas constant R is a measure of the amount of energy desired to increase the temperature of a kilogram of a particular gas by 1 Kelvin or one degree Celsius.

In a further refinement of the method, the discharged refrigerant is mixed, in an intake arrangement of the internal combustion engine, with intake air fed to the inlet side of the internal combustion engine, before the air-refrigerant mixture thus formed is fed to the internal combustion engine, that is to say to the chamber thereof.

The discharged refrigerant is fed to the inlet side of the internal combustion engine such that the discharged refrigerant is added, in an intake arrangement of the internal combustion engine, to prepared intake air that is fed to the internal combustion engine. The expression “intake air” refers to prepared air which is fed to the inlet side of the internal combustion engine, flows into the chambers of the internal combustion engine, and cooperates with a fuel in the chambers of the cylinders of the internal combustion engine.

Here, the preparation of the intake air is to be understood to mean filtering, compression and optionally cooling of the intake air before the thus prepared intake air is fed to the inlet side of the internal combustion engine via an intake arrangement. It is self-evidently also possible for exhaust gases from the internal combustion engine to be added to the intake air, as is conventional in the case of an exhaust-gas recirculation arrangement.

As a result of the discharged refrigerant being added to the intake air, an air-refrigerant mixture is formed which is fed to the inlet side of the internal combustion engine. Proceeding from this air-refrigerant mixture, the feed of fuel such as gasoline, diesel or gas in the internal combustion engine gives rise to an air-refrigerant-fuel mixture, which is burned.

In a further refinement of the method, the discharged refrigerant is fed to the internal combustion engine via a fuel tank of the vehicle.

In this alternative example, the refrigerant discharged via the pressure relief valve of the vehicle air-conditioning system is fed to the fuel tank that is present in the vehicle. A large quantity of a fuel such as gasoline, diesel or gas is stored in such a fuel tank. The fuel is present substantially in liquid form, but also partially or entirely in gaseous form, in the fuel tank.

The discharged refrigerant is fed to the fuel tank which is present, and via this path is also fed to the internal combustion engine. This feed of the discharged refrigerant into the tank is carried out whilst observing the pressure conditions in the fuel tank, such that the discharged refrigerant is fed to the fuel tank only until such time as a specified maximum limit for an internal pressure in the fuel tank is reached. The receiving capacity of the fuel tank varies, and is for example dependent on the present fill level. If the maximum value for the internal pressure in the fuel tank is reached, further discharged refrigerant may be received and temporarily stored in a pressure vessel.

In a particular example of the method, in particular in the event that refrigerant is to be discharged from the pressure relief valve of the vehicle air-conditioning system whilst the internal combustion engine is in a shut-down state, the internal combustion engine may, in one example, firstly be started.

Since the refrigerant discharged from the vehicle air-conditioning system via the pressure relief valve is to be fed to the inlet side of the internal combustion engine for the purposes of combustion in the chambers of the cylinders of the internal combustion engine, it must be provided that the internal combustion engine is in operation. For this reason, the pressure conditions in the vehicle air-conditioning system are continuously detected by means of suitable pressure sensors and are transmitted for example to a central control unit. The central control unit is thus capable of starting the internal combustion engine in good time if the possibility of the refrigerant being discharged via the pressure valve arises whilst the internal combustion engine is in a shut-down state.

It may be particularly advantageous if the starting of the internal combustion engine is carried out if a pressure of the refrigerant in the vehicle air-conditioning system has overshot a specified first pressure threshold.

At least one pressure sensor arranged in the vehicle air-conditioning system is connected, for the purposes of transmitting its measured values, to the central control unit. The central control unit thus has access to current data relating to the pressure in the vehicle air-conditioning system. Such a pressure sensor is, in one example, arranged between a compressor, which is arranged in a refrigerant circuit of the vehicle air-conditioning system, and a condenser.

If the central control unit detects a pressure in the vehicle air-conditioning system which lies above a first specified pressure threshold, the internal combustion engine, if it is in a shut-down state, is started by means of a first control signal generated by the central control unit. The specified first pressure threshold is specified so as to lie below the activation pressure of the pressure relief valve. For example, the first pressure threshold lies in a range between 0.4 MPa and 1.4 MPa lower, in particular is 0.6 MPa lower, than the activation pressure of the pressure relief valve.

The internal combustion engine is thus started in good time before a possible discharge of the refrigerant via the pressure relief valve. If no refrigerant is discharged via the pressure relief valve, the operation of the internal combustion engine may be omitted, and the pressure in the vehicle air-conditioning system lies below a specified second pressure threshold, the internal combustion engine is deactivated by means of a second control signal generated by the central control unit. Here, the second pressure threshold lies below the first pressure threshold.

The present disclosure provides an arrangement for utilizing refrigerant, which has been discharged from a vehicle air-conditioning system, in a vehicle having an internal combustion engine.

Also provided is an arrangement for utilizing refrigerant, which has been discharged from a vehicle air-conditioning system, in a vehicle having an internal combustion engine and a vehicle air-conditioning system that has a pressure relief valve via which refrigerant is discharged when desired, wherein a channel is arranged between the pressure relief valve and an intake arrangement of the internal combustion engine, via which channel the discharged refrigerant is fed to the internal combustion engine via the intake arrangement.

Via a channel which is connected media-tightly to the pressure relief valve and media-tightly to the intake arrangement of the internal combustion engine, the refrigerant discharged via the pressure relief valve is conducted to the internal combustion engine and is burned in the chambers of the cylinders of the internal combustion engine. The discharged refrigerant can therefore enter neither the ambient air nor the interior compartment of the vehicle.

In one example, in the context of the refrigerant, which has been discharged via the pressure relief valve, being fed via the channel between the pressure relief valve and the intake arrangement of the internal combustion engine, the channel may also be connected media-tightly to a pressure compensation vessel. Such a pressure compensation vessel can be used to form a buffer for the refrigerant, which is discharged abruptly at the pressure relief valve. The feed of the discharged refrigerant to the intake arrangement of the internal combustion engine is thus extended over time. This is expedient because, if an excessive quantity of the discharged refrigerant were fed to the internal combustion engine in a very short space of time, this could disrupt the operation of the internal combustion engine. It is also possible for a pressure-reducing valve to be arranged at the transition between the channel and the intake arrangement of the internal combustion engine, which valve limits, to an admissible maximum value, the volume flow rate of the discharged refrigerant that is fed to the internal combustion engine via the intake arrangement.

An injection of the refrigerant into the intake arrangement of the internal combustion engine has the effect of shifting a desired stoichiometric air ratio toward a rich air ratio (excess of fuel), which is detected by a lambda probe and can lead to a reduction of the fuel feed and to rotational speed fluctuations of the internal combustion engine.

According to the method, a suddenly occurring rich fuel mixture in conjunction with an inadmissibly high pressure in the air-conditioning system is detected, and from this it is also possible to infer that a release of pressure has taken place via the pressure relief valve, in order to be able to correspondingly intervene in the engine control, for example in order to inhibit rotational speed fluctuations during the operation of the internal combustion engine.

As a further outcome of the detection of refrigerant being discharged via the pressure relief valve, the driver is prompted to have the vehicle air-conditioning system serviced.

In a further aspect of the disclosure, an arrangement for utilizing a refrigerant, which has been discharged from a vehicle air-conditioning system, in a vehicle comprising an internal combustion engine and a vehicle air-conditioning system is specified, said vehicle air-conditioning system having a pressure relief valve via which the refrigerant is discharged when desired, wherein a channel is arranged between the pressure relief valve and a fuel tank of the vehicle, via which channel the discharged refrigerant is fed to the fuel tank.

In this alternative, via a channel which is connected media-tightly to the pressure relief valve and media-tightly to a fuel tank of the vehicle, the refrigerant discharged via the pressure relief valve is conducted to the fuel tank and is stored therein. Provision may also be made for the refrigerant thus stored to be conveyed with the fuel to the internal combustion engine and thus fed to the internal combustion engine for combustion in the chambers of the cylinders of the internal combustion engine. It is thus also the case in this example that the discharged refrigerant can enter neither the ambient air nor the interior compartment of the vehicle.

In one example, the intake arrangement is an intake manifold of the internal combustion engine.

In an inlet region of an internal combustion engine comprising one or more cylinders, there is commonly arranged an intake manifold via which intake air, in particular prepared intake air, is fed to the one or more cylinders of the internal combustion engine. As a result of the discharged refrigerant being added to the intake air in the intake manifold, an air-refrigerant mixture is formed which is fed to the inlet side of the internal combustion engine. From this air-refrigerant mixture, when fuel such as gasoline, diesel or gas is fed into the internal combustion engine, an air-refrigerant-fuel mixture is formed and is burned.

In one example, a pressure sensor may be arranged in the vehicle air-conditioning system, a starting unit may be arranged on the internal combustion engine, and a central control unit may be arranged in the vehicle, wherein the pressure sensor and the starting unit are connected to the central control unit. Each connection may be of wired or wireless form.

For the purposes of monitoring the pressure in the vehicle air-conditioning system, at least one pressure sensor is arranged for example in a region at an outlet of a compressor of the vehicle air-conditioning system. Said pressure sensor is connected, for the purposes of transmitting its current measured values, to a central control unit arranged in the vehicle. Such a central control unit, which is also referred to as control device, may control not only the method described here but also other operations in the vehicle, for example the proper operation of the vehicle air-conditioning system.

Furthermore, a starting unit is arranged on the internal combustion engine of the vehicle, by means of which starting unit the internal combustion engine is started by way of the first control signal of the central control unit.

The central control unit monitors the measured values of the pressure sensor and thus the pressure conditions in the refrigerant circuit of the vehicle air-conditioning system. The central control unit is thus capable of determining whether the current pressure in the vehicle air-conditioning system in the region of the pressure relief valve is equal to or higher than the specified first pressure threshold. In this case, it is possible for refrigerant to be discharged in a timely manner via the pressure relief valve and fed via the channel to the internal combustion engine. The central control unit also checks the operating state of the internal combustion engine by means of correspondingly connected sensors. If the internal combustion engine is currently in running operation, the refrigerant fed to the internal combustion engine can also be burned. In this case, the central control unit may not intervene in the running operation of the internal combustion engine. If the current pressure in the vehicle air-conditioning system in the region of the pressure relief valve is equal to or higher than the specified first pressure threshold and the internal combustion engine is in a shut-down state, the central control unit generates the first control signal for the starting unit for the purposes of starting the internal combustion engine, in order that this can, in running operation, burn the refrigerant discharged via the pressure relief valve.

In conventional vehicle air-conditioning systems, at least one compressor, a condenser, an expansion valve and an evaporator are arranged in a so-called refrigerant circuit. In one example, the pressure relief valve is arranged at the outlet of the compressor, that is to say between the compressor and the condenser, because the highest pressure prevails in this region of the refrigerant circuit of the vehicle air-conditioning system. To monitor this pressure, the above-described pressure sensor is arranged in this region.

The present disclosure thus provides the reliability and disruption-free operation of vehicle air-conditioning systems in which refrigerants are used.

According to one alternative of the present disclosure, the refrigerant discharged via the pressure relief valve may be fed to the fuel tank. The exemplary relationships discussed below make it possible, on the basis of a known maximum admissible internal pressure in the fuel tank, to determine a maximum admissible quantity of the refrigerant that can be received by the fuel tank.

In one example, it is assumed that 100 g of the refrigerant R290 are discharged from the pressure relief valve.

A discharged mass of 100 g R290 would, in accordance with:
(pressure p in a volume of 10 I, with a content of 100 g R290)

$$p = \frac{m \cdot R \cdot T}{V} = \frac{0 \text{.100} \cdot 188.5 \cdot 300}{10} \cdot \frac{kg \cdot J \cdot K}{kg \cdot K \cdot {dm}^{3}} = 565 , 500 Pa = 5655 hPa$$

lead to a pressure increase of 565 kPa in the fuel tank. The worst case, in which a fill level in the fuel tank is at a maximum, was assumed here, in which case the free volume in the fuel tank is only approximately 10 dm³. In practice, the quantities of the refrigerant discharged through the pressure relief valve lie considerably below the example value of 100 g.

Other alternative refrigerants that may be used according to the disclosure are R600 (butane), R600a (isobutane), R601 (pentane), R601a (isopentane), R1270 (propylene) or R1250 (ethylene).

In a further example, the refrigerant discharged via the pressure relief valve may be fed at least in part via a channel to a cold combustion process using an automatic recombiner process, such as a catalyst reaction. The refrigerant R290 may alternatively be fed into the exhaust section via the catalytic converter. The catalytic converter oxidizes R290 (hydrocarbon) to form CO2 and H2O.

A combustion of hydrogen and oxygen in a recombiner, such as a platinum or palladium catalyst device, is also possible. In this case, the channel is connected media-tightly to the pressure relief valve and media-tightly to the platinum or palladium catalyst device.

It is thus possible, for example, for a proportion of the discharged refrigerant, which for example cannot be fed to the fuel tank, to be converted in the platinum or palladium catalyst device. This alternative variant may self-evidently also be used without any link to the fuel tank, for the purposes of disposing of all of the refrigerant that is discharged via the pressure relief valve.

In a further aspect of the disclosure, it is also possible for one or more of the aforementioned refinements to be combined with one another. For example, the channel may lead both to the intake arrangement and to the fuel tank. For this purpose, a switchable valve may be arranged in a channel branch of the channel, wherein one of the branches could lead to the intake arrangement and the other branch could lead to the fuel tank. The switchable valve may close or open in each case one of the branches, or both branches. The switchable valve also has a wireless or wired connection to the central control unit. Accordingly, if the conditions for conducting the refrigerant into the fuel tank are not met, it would be possible, with corresponding actuation of the switching valve, for the refrigerant to be conducted via the relevant branch into the intake arrangement. If the conditions for introducing the refrigerant into the intake arrangement are not satisfied, it is also conceivable, with corresponding actuation of the switching valve, for the refrigerant to then be conducted via the relevant branch into the fuel tank.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic illustration of a first example of the present disclosure; and

FIG. 2 is a schematic illustration of a second example of the present disclosure.

In the various figures, identical parts are always denoted by the same reference signs, for which reason said parts will generally also be described only once. The expressions “first”, “second” etc. used below and above serve merely for the purposes of distinction. In particular, the use thereof is not intended to imply a sequence or priority of the objects mentioned in conjunction with these expressions.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

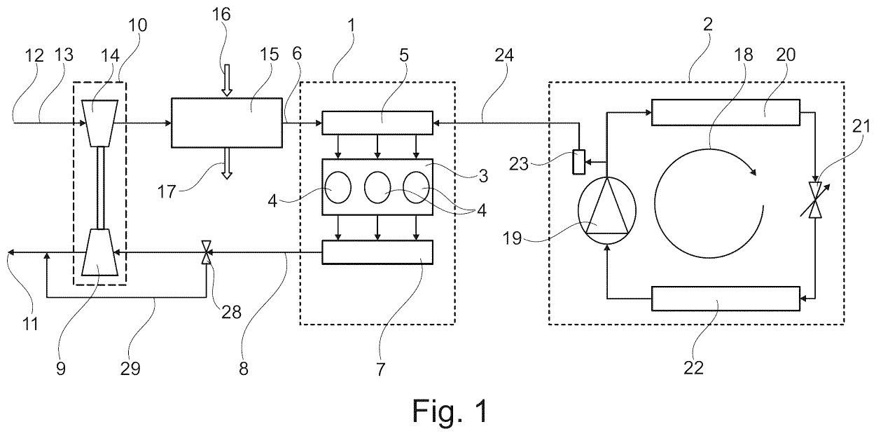

FIG. 1 illustrates a first example of the disclosure, wherein an internal combustion engine 1 and a vehicle air-conditioning system 2 are illustrated with their assemblies that are desired for describing the disclosure.

The internal combustion engine 1 has an engine block 3 in which, for example, three cylinders 4 are arranged. The engine block 3 is connected at an inlet side to an intake arrangement 5 such as an intake manifold, via which intake air 6 is fed to the internal combustion engine 1.

For the preparation of the intake air 6 that is fed to the internal combustion engine 1 via the intake arrangement 5, an exhaust manifold 7 is provided which is arranged at the outlet side on the engine block 3 of the internal combustion engine 1. From the exhaust manifold 7, the exhaust gases 8 of the internal combustion engine 1 are conducted via a turbine side 9 of a turbocharger 10 to an exhaust-gas outlet 11. An exhaust system (not illustrated) is commonly arranged at such an exhaust-gas outlet 11. As can be seen in FIG. 1, a charge-pressure control valve 28 is arranged between the exhaust manifold 7 and the turbine side 9 of a turbocharger 10 and is connected to a bypass 29 that bypasses the turbocharger 10.

Fresh air 13 is drawn in via a fresh-air inlet 12 and is compressed on the compressor side 14 of the exhaust-gas-driven turbocharger 10. Compressed air in the form of prepared intake air 6 for the internal combustion engine 1 is thus generated by means of the exhaust gases 8 emitted by the internal combustion engine 1. To enhance the effectiveness of the internal combustion engine 1, the intake air 6 that warms up during the compression on the compressor side 14 of the turbocharger 10 is cooled in a downstream charge-air cooler 15, before the intake air 6 prepared in this way is fed to the internal combustion engine 1 via the intake arrangement 5. Cool air 16 from the surroundings is fed to the inlet side of the charge-air cooler 15. Warm air 17 exits the charge-air cooler 15 at the outlet side.

From the charge-air cooler 15, the cooled, prepared intake air 6 is fed to the internal combustion engine 1 via the intake arrangement 5. The preparation of the intake air 6 includes not only compression and cooling but commonly also filtering, which is not illustrated in FIG. 1.

The vehicle air-conditioning system 2 has a refrigerant circuit 18 in which a compressor 19, a condenser 20, an expansion valve 21 and an evaporator 22 are arranged in a process direction of the refrigerant circuit 18. The process direction is indicated by the arrow tips.

A pressure relief valve 23 is arranged at an outlet of the compressor 19, in a region between the compressor 19 and the condenser 20. By means of the pressure relief valve 23, which may also be integrated into the compressor 19, refrigerant is discharged if the pressure in the refrigerant circuit 18 at the installation position of the pressure relief valve 23 overshoots a particular threshold. When using R290, said pressure threshold may for example lie in a range between 3.3 MPa and 4.0 MPa.

A channel 24 is arranged between the pressure relief valve 23 and the intake arrangement 5 of the internal combustion engine 1. At a first end, the channel 24 is connected media-tightly to an outlet of the pressure relief valve 23, via which the refrigerant is discharged when desired. At a second end, the channel 24 is furthermore connected media-tightly to the intake arrangement 5 of the internal combustion engine 1. Such a media-tight connection inhibits the refrigerant from escaping into the ambient air from a system that comprises the vehicle air-conditioning system 2 and the internal combustion engine 1.

It is thus provided that refrigerant discharged via the pressure relief valve 23 is fed to the internal combustion engine 1 via the intake arrangement 5.

As a result of the discharged refrigerant being added to the intake air 6 in the intake arrangement 5, an air-refrigerant mixture is formed which is fed to the inlet side of the internal combustion engine 1. Proceeding from this air-refrigerant mixture, the feed of fuel such as gasoline, diesel or gas in the internal combustion engine 1 gives rise to an air-refrigerant-fuel mixture, which is burned in the combustion chambers of the cylinders 4 of the internal combustion engine 1. To better control the feed of the discharged refrigerant to the intake air 6, it is for example possible for a control valve which reduces the pressure of the discharged refrigerant to be provided in the region between the channel 24 and the intake arrangement 5. Furthermore, the channel 24 may be connected to a pressure compensation vessel by means of which pressure fluctuations, in particular a pressure shock when the pressure relief valve 23 opens, can be dampened. FIG. 1 does not illustrate such a control valve or such a pressure compensation vessel.

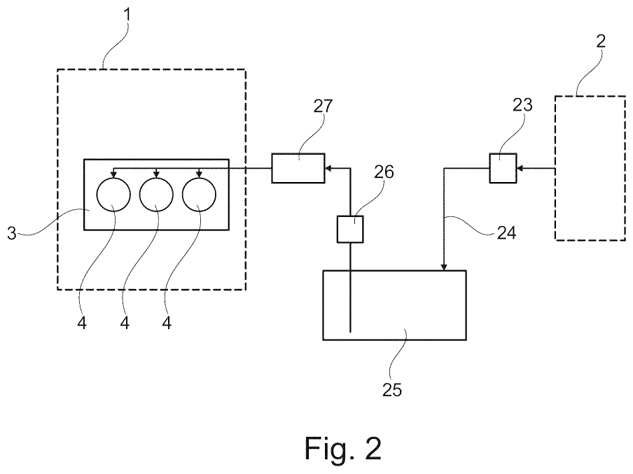

FIG. 2 illustrates a second example of the disclosure.

FIG. 2 illustrates the internal combustion engine 1 only with its engine block 3 and the cylinders 4, by way of example. The vehicle air-conditioning system 2 is also illustrated in simplified form in relation to FIG. 1.

In this second example of the disclosure, the refrigerant discharged via the pressure relief valve 23 is conveyed via the channel 24 to a fuel tank 25 of the vehicle. FIG. 2, which illustrates merely the principle, does not illustrate measures for pressure reduction and/or pressure monitoring in the fuel tank 25.

In this example, at its first end, the channel 24 is connected media-tightly to the outlet of the pressure relief valve 23, via which the refrigerant is discharged when desired. At its second end, the channel 24 is furthermore connected media-tightly to the fuel tank 25. A fuel-refrigerant mixture forms in the fuel tank 25.

The fuel-refrigerant mixture is conveyed from the fuel tank 25 to an injection arrangement 27 by means of a pump 26, for example. Via the injection arrangement 27, the fuel-refrigerant mixture is metered into the chambers of the cylinders 4 of the internal combustion engine 1 and is burned.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method for utilizing a refrigerant, which has been discharged from a vehicle air-conditioning system, the method comprising:
providing a vehicle having an internal combustion engine and the vehicle air-conditioning system, the vehicle air-conditioning system including a pressure relief valve;
discharging the refrigerant via the pressure relief valve; and
feeding the refrigerant that has been discharged from the vehicle air-conditioning system via the pressure relief valve to the internal combustion engine.

2. The method of claim 1, further comprising mixing the discharged refrigerant, in an intake arrangement of the internal combustion engine, with intake air fed to an inlet side of the internal combustion engine, prior to the feeding of the refrigerant to the internal combustion engine.

3. The method of claim 1, further comprising providing a fuel tank of the vehicle, wherein the discharged refrigerant is fed to the internal combustion engine via the fuel tank of the vehicle.

4. The method of claim 1, further comprising starting the internal combustion engine before the refrigerant is discharged from the pressure relief valve of the vehicle air-conditioning system based on the internal combustion engine being in a shut-down state.

5. The method of claim 4, wherein the starting of the internal combustion engine is based on a pressure of the refrigerant in the vehicle air-conditioning system being greater than a first pressure threshold.

6. A system for utilizing a refrigerant in a vehicle, the system comprising:
an internal combustion engine;
a vehicle air-conditioning system;
a pressure relief valve to discharge the refrigerant associated with the vehicle air-conditioning system; and
a channel that fluidly couples the pressure relief valve to the internal combustion engine to feed the discharged refrigerant to the internal combustion engine.

7. The system of claim 6, wherein the channel is arranged between the pressure relief valve and an intake arrangement of the internal combustion engine.

8. The system of claim 6, wherein the channel is arranged between the pressure relief valve and a fuel tank of the vehicle.

9. The system of claim 6, wherein the discharged refrigerant is fed to the internal combustion engine via an intake arrangement associated with the internal combustion engine.

10. The system of claim 6, wherein the discharged refrigerant is fed to the internal combustion engine via a fuel tank associated with the vehicle.

11. The system of claim 9, wherein the intake arrangement is an intake manifold of the internal combustion engine.

12. The system of claim 6, further comprising:
a pressure sensor arranged in the vehicle air-conditioning system;
a starting unit arranged on the internal combustion engine; and
a central control unit arranged in the vehicle, and the pressure sensor and the starting unit are connected to the central control unit.

13. The system of claim 6, further comprising a refrigerant circuit arranged in the vehicle air-conditioning system, the refrigerant circuit including a compressor, a condenser, an expansion valve and an evaporator that are interconnected, and wherein the pressure relief valve is arranged at an outlet of the compressor.

14. A system for utilizing a refrigerant in a vehicle, the system comprising:
an internal combustion engine including an intake arrangement;
a vehicle air-conditioning system;
a fuel tank;
a pressure relief valve to discharge the refrigerant associated with the vehicle air-conditioning system; and
a channel that couples the pressure relief valve to one of the fuel tank and the intake arrangement to feed the discharged refrigerant to the internal combustion engine.

15. The system of claim 14, wherein the channel is arranged between the pressure relief valve and the intake arrangement of the internal combustion engine.

16. The system of claim 14, wherein the channel is arranged between the pressure relief valve and the fuel tank of the vehicle.

17. The system of claim 14, wherein the intake arrangement is an intake manifold of the internal combustion engine.

18. The system of claim 14, further comprising a refrigerant circuit arranged in the vehicle air-conditioning system, the refrigerant circuit including a compressor, a condenser, an expansion valve and an evaporator that are interconnected, and wherein the pressure relief valve is arranged at an outlet of the compressor.

19. The system of claim 14, further comprising:
a pressure sensor arranged in the vehicle air-conditioning system;
a starting unit arranged on the internal combustion engine; and
a central control unit arranged in the vehicle, and the pressure sensor and the starting unit are connected to the central control unit.

20. The system of claim 19, wherein the central control unit is configured to generate a first control signal for the starting unit to start the internal combustion engine based on the internal combustion engine being in a shut-down state.
